(19) United States
(12) Patent Application Publication
(10) Pub. No.: US 2013/0332385 A1
(43) Pub. Date: Dec. 12, 2013

(54) METHODS AND SYSTEMS FOR DETECTING AND EXTRACTING PRODUCT REVIEWS

(71) Applicants: Jonathan Kilroy, Champaign, IL (US); Allie K. Watfa, Urbana, IL (US); Dale Nussel, Mahomet, IL (US); Mangesh Pardeshi, Champaign, IL (US)

(72) Inventors: Jonathan Kilroy, Champaign, IL (US); Allie K. Watfa, Urbana, IL (US); Dale Nussel, Mahomet, IL (US); Mangesh Pardeshi, Champaign, IL (US)

(73) Assignee: Yahoo! Inc., Sunnyvale, CA (US)

(21) Appl. No.: 13/493,481

(22) Filed: Jun. 11, 2012

(51) Int. Cl. G06Q 30/00

(52) U.S. Cl. 705/347

(57) ABSTRACT

Techniques are provided which collect user generated online review information related to a product, and detecting at least information related to an assessment or opinion related to the product included within user generated online communication information. The information related to an assessment or opinion related to the product may be extracted. It may be determined whether the online review information and the information related to an assessment or opinion include fraudulent information. The fraudulent information from the online review information and the information related to an assessment or opinion may be filtered out to generate genuine online review information and genuine information related to an assessment or opinion. The genuine online review information and the genuine information related to an assessment or opinion may each be assigned respective weights, and integrated to create a review summary for the product.

### BACKGROUND

With the advent of broadband internet, online shopping has grown in popularity. People are often influenced by the feedback, comments and opinions of others before, for example, making a purchase. Thus, online shoppers typically consult online reviews before making a purchase.

However, online reviews for products are typically scattered across multiple sources. In addition, most consumers who purchase a product don't take the time to write an online review, even if they are satisfied with the product.

Accordingly, there is a need for a system capable of aggregating user generated online review information and integrating it with user generated opinion or assessment information related to the product.

### SUMMARY

Some embodiments of the invention provide systems and methods which detect and extract product review information. User generated online review information related to a product may be collected. The user generated online review information may include an analysis, opinion and/or assessment of the product or its features written by users who have purchased, used or reviewed the product. The review information may be collected by for example using a search engine to conduct periodical searches. The search engine may search sources which are likely to contain review information such as for example, retailers (e.g., Amazon.com), product manufacturer websites, online auction marketplaces (e.g., ebay.com), etc. In some embodiments, the review information may be collected for a particular time period (e.g., last six months). Alternatively, review information for the entire time period that the product has been available for sale may be collected.

In addition to collecting review information, at least information related to an assessment or opinion related to the product included within user generated online communication information may be detected. The information related to an assessment or opinion may be detected from communication information from sources which don't typically include product reviews such as for example, instant messages (IMs), social network platform posts (e.g., Facebook® status updates, Tweets®, etc.). In addition, the information related to an assessment or opinion may not have been intended to be written as a review. To illustrate by way of example, a user who has purchased or used a product may, instead of or in addition to writing a formal review, chose to communicate to friends and family about the product (e.g., “This product is awesome”) using an IM, social network status update, email, etc. In another example, the user may post on a blog, forum or messageboard. In some embodiments, detecting the information related to an assessment or opinion may include collecting user generated online communication information from various sources such as social networking platforms, forums, blogs, etc. The information related to an assessment or opinion related to the product may be extracted.

It may be determined whether the online review information and the information related to an assessment or opinion includes fraudulent information. The fraudulent information may include for example, fake reviews, or spam reviews, etc. The fake reviews may have been written for example to boost a product's rating. The fraudulent information may be detected a number of ways. For example, the reviewer's (e.g., the person who wrote the review) user ID may be searched to see if other reviews have been posted using the same user ID. If a large number of reviews have been posted using the same user ID, it is likely that the review is not genuine. Other methods include analyzing the language of the review to determine if it is overly complimentary. In another example, the IP address of the reviewer may be used to determine if the review is genuine. For instance, if multiple reviews of the same product are posted from the same IP address, it is likely that they are not authentic. In yet another example, reviews that have been flagged or “disliked” by other users are likely to not be genuine. The fraudulent information may be filtered out from the online review information and the information related to an assessment or opinion to generate genuine online review information and genuine information related to an assessment or opinion. The genuine online review information and the genuine information related to an assessment or opinion related to the product may be integrated to create a review summary for the product. In some embodiments, a star rating may be assigned to the product based at least in part on the genuine online review information and the genuine information related to an assessment or opinion related to the product. The review summary may include the genuine review information and the genuine information related to an assessment or opinion related to the product, which may be sorted by the user based on a number of variables (e.g. by time, date, etc.). The review summary may also include additional information such as price information and warranty information related to the product. In some embodiments, the review summary may also include information such as the number of reviews that were used to create the summary, the number of reviews that were fraudulent or spam, the number of reviews that were highly ranked, and the number of reviews that were extracted from communications from “non-review” sources (e.g., social networking platform, forum, blog, IMs, email, etc.).

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

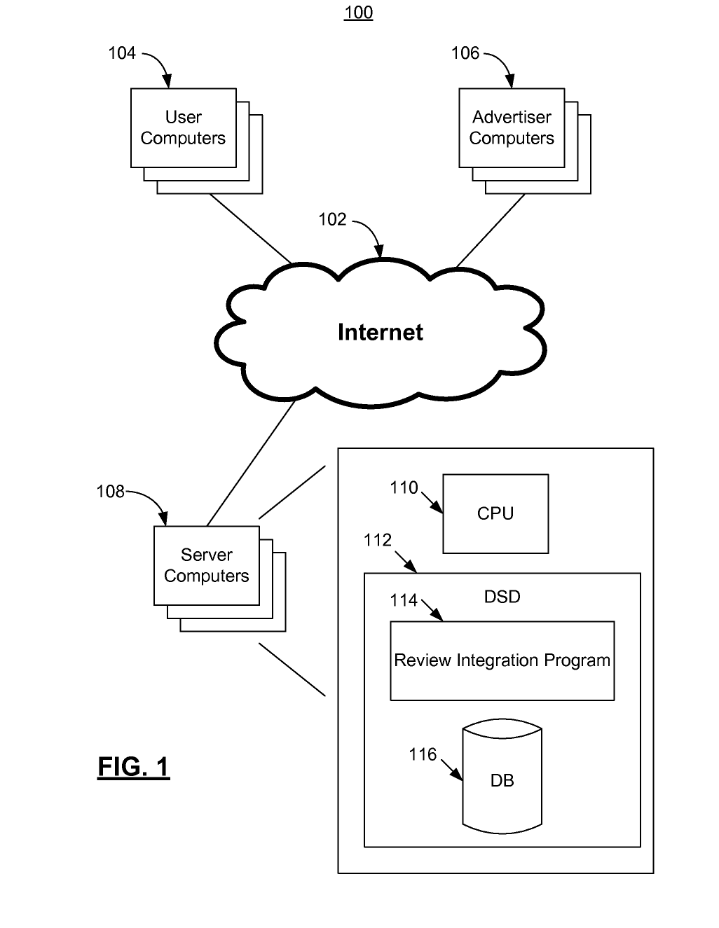

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as smart phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Review Integration Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

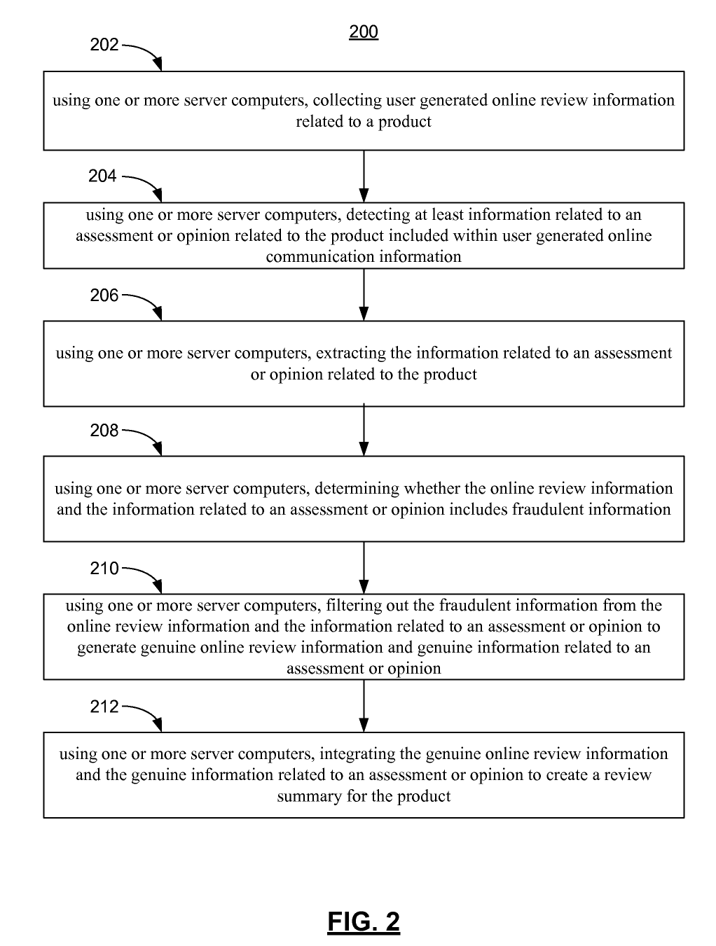

FIG. 2 is a flow diagram illustrating a method 200 according to one embodiment of the invention. At step 202, using one or more server computers, user generated online review information related to a product may be collected. The user generated online review information may include an analysis, opinion and/or assessment of the product or its features written by users who have purchased, used or reviewed the product. The review information may be collected by for example using a search engine to conduct periodical searches. In some embodiments, a periodic search may be conducted (e.g., once a week) to search for products and reviews. The search may eliminate (e.g., if a product is no longer for sale) or add a product (e.g., if a new product is added), and may capture the associated reviews of a product. The captured data may be stored in for example, cloud storage and may be updated to include data detailing products and their reviews that has been captured with the periodic search.

As will be apparent to one of ordinary skill in the art, cloud storage is a model of networked online storage where data is stored on virtualized pools of storage. The data center operators virtualize the resources according to the requirements of the customer and expose them as storage pools, which the customers can themselves use to store files or data objects. Physically, the resources may span across multiple servers. In some embodiments, cloud computing may also be used to capture the data. The search engine may search sources which are likely to contain review information such as for example, retailers (e.g., Amazon.com), product manufacturer websites, online auction marketplaces (e.g., ebay.com), etc. In some embodiments, the review information may be collected for a particular time period (e.g., last six months). Alternatively, review information for the time period that the product has been available for sale may be collected.

At step 204, using one or more server computers, at least information related to an assessment or opinion related to the product included within user generated online communication information may be detected. The information related to an assessment or opinion may be detected from communication information from sources which don't typically include product reviews such as for example, instant messages (IMs), social network platform posts (e.g., Facebook® status updates, Tweets®, etc.). In addition, the information related to an assessment or opinion may not have been intended to be written as a review. To illustrate by way of example, a user who has purchased or used a product may, instead of or in addition to writing a formal review, chose to communicate to friends and family about the product (e.g., “This product is awesome”) using an IM, social network status update, email, etc. In another example, the user may post on a blog, forum or messageboard. In some embodiments, detecting the information related to an assessment or opinion may include collecting user generated online communication information from various sources such as social networking platforms, forums, blogs, etc. As discussed above, the information may be collected by for example using a search engine to conduct periodical searches. At step 206, using one or more server computers, the information related to an assessment or opinion related to the product may be extracted. In some embodiments, the information may be extracted from the information that was collected from the search.

At step 208, using one or more server computers, it is determined whether the online review information and the information related to an assessment or opinion includes fraudulent information. The fraudulent information may include for example, fake reviews, or spam reviews, etc. The fake reviews may have been written for example to boost a product's rating. The fraudulent information may be detected a number of ways. For example, the reviewer's (e.g., the person who wrote the review) user ID may be searched to see if other reviews have been posted using the same user ID. If a large number of reviews have been posted using the same user ID, it is likely that the review is not genuine. Other methods include analyzing the language of the review to determine if it is overly complimentary. In another example, the IP address of the reviewer may be used to determine if the review is genuine. For instance, if multiple reviews of the same product are posted from the same IP address, it is likely that they are not authentic. In yet another example, reviews that have been flagged or “disliked” by other users are likely to not be genuine. Both the online review information and the information related to an assessment or opinion may be checked to determine if they include fraudulent information. At step 210, using one or more server computers, the fraudulent information may be filtered out from the online review information and the information related to an assessment or opinion to generate genuine online review information and genuine information related to an assessment or opinion.

At step 212, using one or more server computers, the genuine online review information and the genuine information related to an assessment or opinion related to the product may be integrated to create a review summary for the product. In some embodiments, a star rating may be assigned to the product based at least in part on the genuine online review information and the genuine information related to an assessment or opinion related to the product. The review summary may include the genuine review information and the genuine information related to an assessment or opinion related to the product, which may be sorted by the user based on a number of variables (e.g. by time, type, rating, etc.). The review summary may also include additional information such as price information and warranty information related to the product. In some embodiments, the review summary may also include information such as the number of reviews that were used to create the summary, the number of reviews that were fraudulent or spam, the number of reviews that were highly ranked, and the number of reviews that were extracted from communications from “non-review” sources (e.g., social networking platform, forum, blog, IMs, email, etc.).

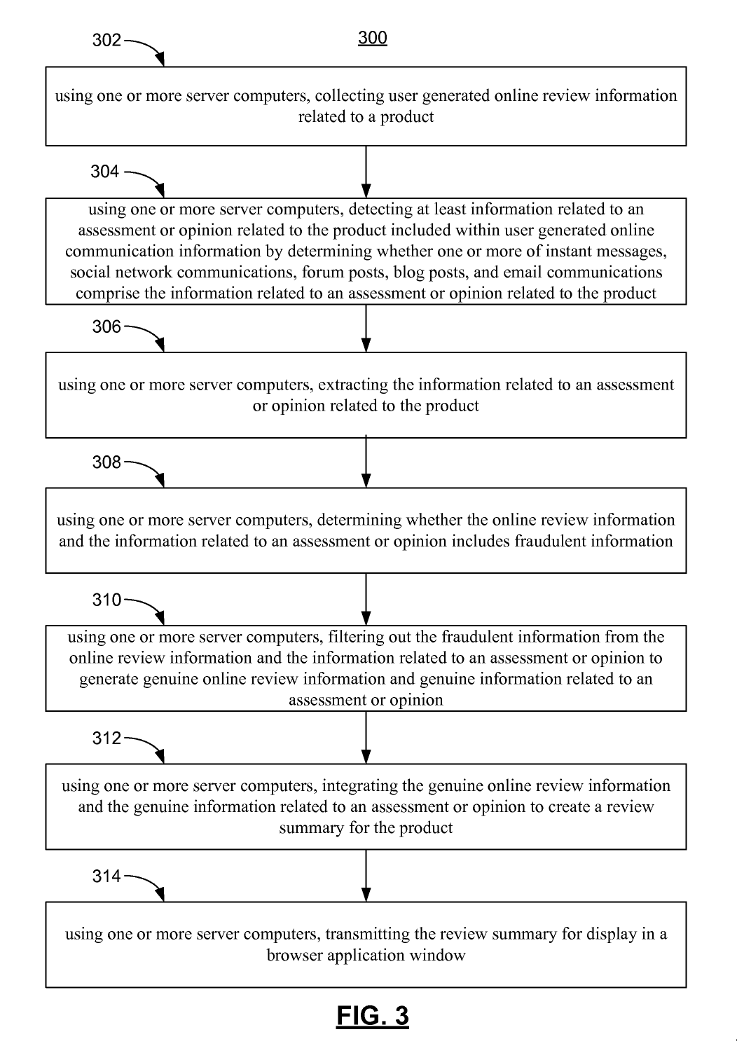

FIG. 3 is a flow diagram illustrating a method 300 according to one embodiment of the invention. At step 302, using one or more server computers, user generated online review information related to a product may be collected. The user generated online reviews include an analysis, opinion and/or assessment of the product or its features written by users who have purchased, used or reviewed the product. The review information may be collected by for example using a search engine to conduct periodical searches. The search engine may search sources which are likely to contain review information such as for example, retailers (e.g., Amazon.com), product manufacturer websites, online auction marketplaces (e.g., ebay.com), etc. In some embodiments, the review information may be collected for a particular time period (e.g., last six months). Alternatively, review information for the time period that the product has been available for sale may be collected.

At step 304, using one or more server computers, at least information related to an assessment or opinion related to the product included within user generated online communication information may be detected by determining whether one or more of instant messages, social network communications, forum posts, blog posts, and email communications comprise the information related to an assessment or opinion related to the product. The information related to an assessment or opinion may be detected from communication information from sources which don't typically include product reviews such as for example, instant messages (IMs), social network platform posts (e.g., Facebook® status updates, Tweets®, etc.). In addition, the information related to an assessment or opinion may not have been intended to be written as a review. To illustrate by way of example, a user who has purchased or used a product may, instead of or in addition to writing a formal review, chose to communicate to friends and family about the product (e.g., “This product is awesome”) using an IM, social network status update, email, etc. In another example, the user may post on a blog, forum or messageboard. In some embodiments, detecting the information related to an assessment or opinion may include collecting user generated online communication information from various sources such as social networking platforms, forums, blogs, etc. As discussed above, the information may be collected by for example using a search engine to conduct periodical searches. At step 306, using one or more server computers, the information related to an assessment or opinion related to the product may be extracted. In some embodiments, the information may be extracted from the information that was collected from the search.

At step 308, using one or more server computers, it is determined whether the online review information and the information related to an assessment or opinion includes fraudulent information. The fraudulent information may include for example, fake reviews, or spam reviews, etc. The fake reviews may have been written for example to boost a product's rating. The fraudulent information may be detected a number of ways. For example, the reviewer's (e.g., the person who wrote the review) user ID may be searched to see if other reviews have been posted using the same user ID. If a large number of reviews have been posted using the same user ID, it is likely that the review is not genuine. Other methods include analyzing the language of the review to determine if it is overly complimentary. In another example, the IP address of the reviewer may be used to determine if the review is genuine. For instance, if multiple reviews of the same product are posted from the same IP address, it is likely that they are not authentic. In yet another example, reviews that have been flagged or “disliked” by other users are likely to not be genuine. Both the online review information and the information related to an assessment or opinion may be checked to determine if they include fraudulent information. At step 310, using one or more server computers, the fraudulent information may be filtered out from the online review information and the information related to an assessment or opinion to generate genuine online review information and genuine information related to an assessment or opinion.

At step 312, using one or more server computers, the genuine online review information and the genuine information related to an assessment or opinion related to the product may be integrated to create a review summary for the product. In some embodiments, a star rating may be assigned to the product based at least in part on the genuine online review information and the genuine information related to an assessment or opinion related to the product. The review summary may include the genuine review information and the genuine information related to an assessment or opinion related to the product, which may be sorted by the user based on a number of variables (e.g. by time, type, rating, etc.). The review summary may also include additional information such as price information and warranty information related to the product. In some embodiments, the review summary may also include information such as the number of reviews that were used to create the summary, the number of reviews that were fraudulent or spam, the number of reviews that were highly ranked, and the number of reviews that were extracted from communications from “non-review” sources (e.g., social networking platform, forum, blog, IMs, email, etc.). At step 314, using one or more server computers, the review summary may be transmitted to a browser application for display in the browser application. In one embodiment, the review summary may be transmitted in response to a user visiting a website.

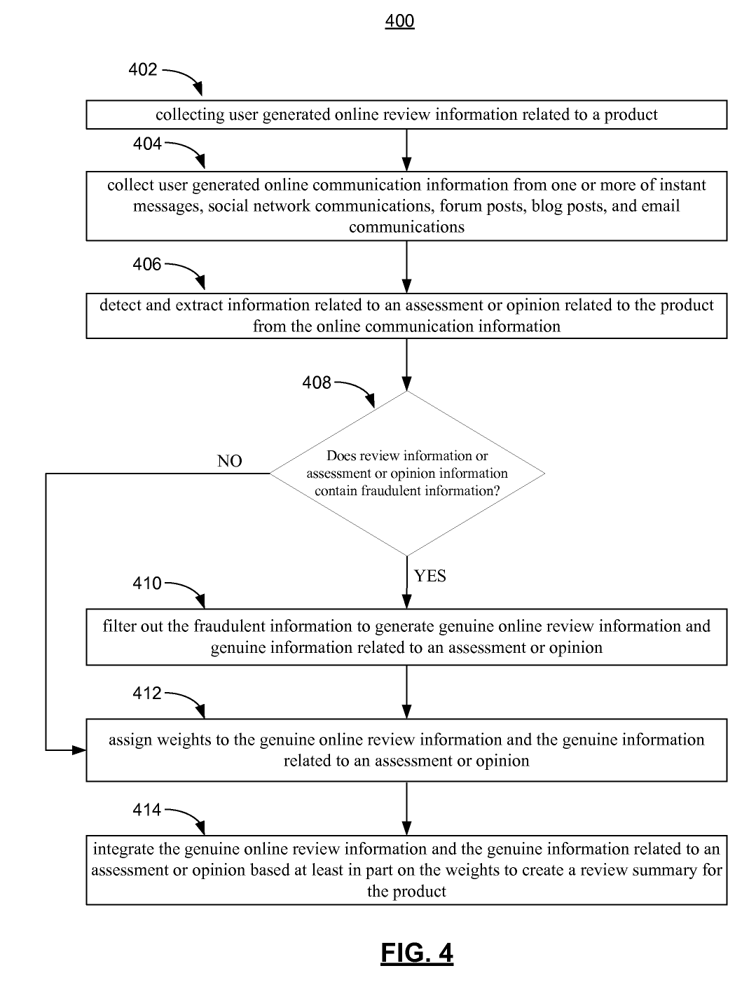

FIG. 4 is a flow diagram illustrating a method 400 according to one embodiment of the invention. At step 402, user generated online review information related to a product may be collected. The user generated online review information may include an analysis, opinion and/or assessment of the product or its features written by users who have purchased, used or reviewed the product. The review information may be collected by for example using a search engine to conduct periodical searches. In some embodiments, a periodic search may be conducted (e.g., once a week) to search for products and reviews. The search may eliminate (e.g., if a product is no longer for sale) or add a product (e.g., if a new product is added), and may capture the associated reviews of a product. The captured data may be stored in for example, cloud storage and may be updated to include data detailing products and their reviews that has been captured with the periodic search.

The search engine may search sources which are likely to contain review information such as for example, retailers (e.g., Amazon.com), product manufacturer websites, online auction marketplaces (e.g., ebay.com), etc. In some embodiments, the review information may be collected for a particular time period (e.g., last six months). Alternatively, review information for the time period that the product has been available for sale may be collected.

At step 404, user generated online communication information may be collected from one or more of instant messages, social network communications, forum posts, blog posts, and email communications. As discussed above, the online communication information may be collected by for example, using a search engine to conduct periodical searches. At step 406, information related to an assessment or opinion related to the product may be detected and extracted from the online communication information. To illustrate by way of example, a user who has purchased or used a product may, instead of or in addition to writing a formal review, chose to communicate to friends and family about the product (e.g., “This product is awesome”) using an IM, social network status update, email, etc. In another example, the user may post on a blog, forum or messageboard.

At step 408, it is determined whether the online review information or the information related to an assessment or opinion includes fraudulent information. The fraudulent information may include for example, fake reviews, or spam reviews, etc. The fake reviews may have been written for example to boost a product's rating. The fraudulent information may be detected a number of ways. For example, the reviewer's (e.g., the person who wrote the review) user ID may be searched to see if other reviews have been posted using the same user ID. If a large number of reviews have been posted using the same user ID, it is likely that the review is not genuine. Other methods include analyzing the language of the review to determine if it is overly complimentary. In another example, the IP address of the reviewer may be used to determine if the review is genuine. For instance, if multiple reviews of the same product are posted from the same IP address, it is likely that they are not authentic. In yet another example, reviews that have been flagged or “disliked” by other users are likely to not be genuine. Both the online review information and the information related to an assessment or opinion may be checked to determine if they include fraudulent information. At step 410, the fraudulent information may be filtered out from the online review information and the information related to an assessment or opinion to generate genuine online review information and genuine information related to an assessment or opinion.

At step 412, the genuine online review information and the genuine information related to an assessment or opinion of the product may be assigned respective weights based at least in part on one or more factors. The factors include for example, the time the review or assessment or opinion was written (e.g., how recent is the review, assessment or opinion), the version of the product for which the review or assessment or opinion was written (e.g., is it for an older version of the product?), the quality of the review or assessment or opinion (e.g., determined based on the number of “likes” or “dislikes”, or if it has been flagged by other users), etc. In one embodiment, the weight may be determined based at least in part on:

Weight=(number of positive likes−number of negative likes (e.g., “dislikes”))−(days of recency*(10/90))+(is product version latest)+(is review extracted or actual)

In the above equation, the number of positive likes and the number of negative likes correspond to the number of likes, and dislikes, respectively. Days of recency corresponds to the number of days the review or assessment or opinion has been posted online (maximum of 90). “Is product version latest” will have a value of either 1 or 0 corresponding to yes or no, respectively. “Is review extracted or actual” corresponds to whether the “review” being weighted is an actual review (e.g., written as a review) or if it was extracted from a user generated online communication (e.g., from a social network post, etc.), and will have a value of either 1 or 0 corresponding to actual or extracted, respectively.

At step 414, the genuine online review information and the genuine information related to an assessment or opinion related to the product may be integrated based at least in part on the respective weights to create a review summary for the product. In some embodiments, a star rating may be assigned to the product based at least in part on the respective weights of the genuine online review information and the genuine information related to an assessment or opinion related to the product. The review summary may include the genuine review information and the genuine information related to an assessment or opinion related to the product, which may be sorted by the user based on a number of variables (e.g. by time, type, rating, etc.). In some embodiments, the genuine review information and the genuine information related to an assessment or opinion related to the product may be ranked based at least in part on the respective weights. The review summary may also include additional information such as price information and warranty information related to the product. In some embodiments, the review summary may also include information such as the number of reviews that were used to create the summary, the number of reviews that were fraudulent or spam, the number of reviews that were highly ranked, and the number of reviews that were extracted from communications from “non-review” sources (e.g., social networking platform, forum, blog, IMs, email, etc.).

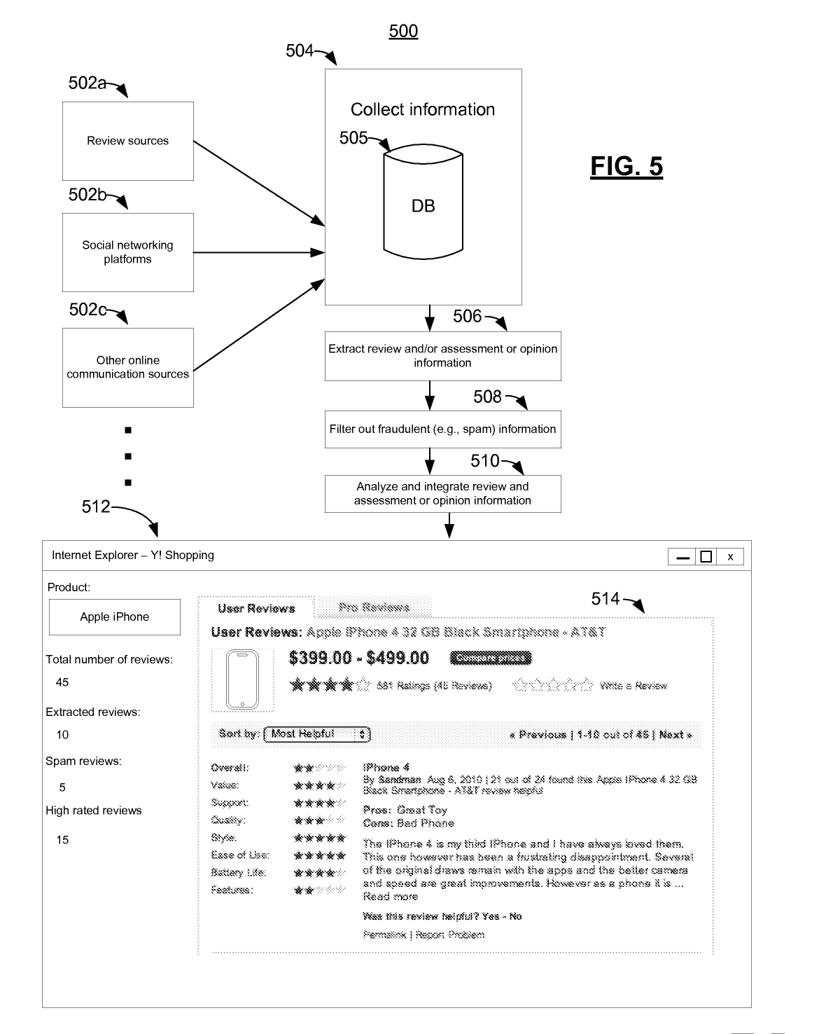

FIG. 5 is a block diagram 500 according to one embodiment of the invention. One or more data stores or databases 505 are depicted. As depicted in block 504, various types of information may be collected and stored in database 505. In particular, types of depicted information stored in database 505 include, potentially among many other types of information, user generated online review information collected from review sources 502a (e.g., retailers, manufacturer websites, online marketplaces, etc.), user generated online communication information collected from social networking platforms 502b (e.g., Facebook status updates, Tweets, etc.), user generated online communication information collected from other communication sources 502c (e.g., email, IMs, forums blogs, etc), etc.

As depicted in block 506, review information and information related to an assessment or opinion related to the product may be detected and extracted from the collected information. In block 508, fraudulent information is detected and filtered out from the online review information or the information related to an assessment or opinion to generate genuine online review information and genuine information related to an assessment or opinion. The fraudulent information may include for example, fake reviews, or spam reviews, etc. The fraudulent information may be detected a number of ways. For example, the reviewer's (e.g., the person who wrote the review) user ID may be searched to see if other reviews have been posted using the same user ID. If a large number of reviews have been posted using the same user ID, it is likely that the review is not genuine. Other methods include analyzing the language of the review to determine if it is overly complimentary. In another example, the IP address of the reviewer may be used to determine if the review is genuine. For instance, if multiple reviews of the same product are posted from the same IP address, it is likely that they are not authentic. In yet another example, reviews that have been flagged or “disliked” by other users are likely to not be genuine. Both the online review information and the information related to an assessment or opinion may be checked to determine if they include fraudulent information.

At step 510, the genuine online review information and the genuine information related to an assessment or opinion of the product may be analyzed and assigned respective weights based at least in part on one or more factors, and integrated to form a review summary based at least in part on the respective weights. The factors include for example, the time the review or assessment or opinion was written (e.g., how recent is the review, assessment or opinion), the version of the product for which the review or assessment or opinion was written (e.g., is it for an older version of the product?), the quality of the review or assessment or opinion (e.g., determined based on the number of “likes” or “dislikes”, or if it has been flagged by other users), etc. As discussed above, in one embodiment, the weight may be determined based at least in part on:

Weight=(number of positive likes−number of negative likes (e.g., “dislikes”))−(days of recency*(10/90))+(is product version latest)+(is review extracted or actual)

Screenshot 512 of a website depicts one example of review summary 514 in accordance with one embodiment of the invention. In some embodiments, the review summary may include a star rating assigned to the product based at least in part on the respective weights of the genuine online review information and the genuine information related to an assessment or opinion related to the product. The review summary may include the genuine review information and the genuine information related to an assessment or opinion related to the product, which may be sorted by the user based on a number of variables (e.g. by time, type, rating, etc.). The review summary may also include additional information such as price information and warranty information (not shown) related to the product. In some embodiments, the review summary may also include information such as the number of reviews that were used to create the summary, the number of reviews that were fraudulent or spam, the number of reviews that were highly ranked, and the number of reviews that were extracted from communications from “non-review” sources (e.g., social networking platform, forum, blog, IMs, email, etc.).

While the invention is described with reference to the above drawings, the drawings are intended to be illustrative, and the invention contemplates other embodiments within the spirit of the invention.

1. A method comprising:
collecting, using one or more server computers, user generated online review information related to a particular product, wherein the user generated online review information is generated in a formal review format, wherein the format is provided by a commercial source and wherein the generated online review is stored with the commercial source, wherein the commercial source includes retailers, product manufacturers, auction marketplaces or commercial websites;
detecting, using one or more server computers, at least online communication information related to an assessment or opinion related to the particular product included within user generated online communication information, wherein user generated online communication information includes instant messages, social network communications, forum posts, blog posts, or email communications, and wherein the user generated online communication information does not include the user generated online review information and is generated in an opinion format and using social communication sources, including instant messengers, social networks, user interest forums, user interest blogs, or email communication sources;
extracting, using one or more server computers, the online communication information related to an assessment or opinion related to the particular product;
determining, using one or more server computers, whether the online review information and the online communication information related to an assessment or opinion includes fraudulent information;
filtering out, using one or more server computers, the fraudulent information from the online review information and the online communication information related to an assessment or opinion to generate genuine online review information and genuine online communication information related to an assessment or opinion, wherein generating genuine online review information and genuine online communication information is based on at least one or more internet protocol addresses associated with the online review information and the online communication information; and
integrating, using one or more server computers, the genuine online review information and the genuine online communication information related to an assessment or opinion to create a review summary for the product.

2. The method of claim 1, further comprising:
assigning a weight to each of the genuine online review information and the genuine online communication information related to an assessment or opinion.

3. The method of claim 1, wherein collecting the user generated online review information comprises periodically searching for the user generated online review information.

4. The method of claim 1, wherein detecting online communication information related to an assessment or opinion related to the product comprises determining whether one or more of instant messages, social network communications, forum posts, blog posts, and email communications comprise the online communication information related to an assessment or opinion related to the product.

5. The method of claim 2, wherein generating a review summary comprises ranking the genuine online review information and the genuine online communication information related to an assessment or opinion based at least in part on the respective weight.

6. The method of claim 1, wherein generating a review summary comprises assigning a star rating to the product based at least in part on the genuine online review information and the genuine online communication information related to an assessment or opinion.

7. The method of claim 1, wherein the review summary comprises price related information for the product.

8. The method of claim 2, wherein the weight is assigned based at least in part on one or more of a number of likes or dislikes assigned to the genuine online review information, an age of the genuine online review information and the genuine online communication information related to an assessment or opinion.

9. The method of claim 1, further comprising:
transmitting, using one or more server computers, the review summary for display in a browser application window.

10. A system comprising:
one or more server computers coupled to a network; and
one or more databases coupled to the one or more server computers;
wherein the one or more server computers are for:
collecting user generated online review information related to a particular product, wherein the user generated online review information is generated in a formal review format, wherein the format is provided by a commercial source and wherein the generated online review is stored with the commercial source, wherein the commercial source includes retailers, product manufacturers, auction marketplaces or commercial websites;
detecting at least online communication information related to an assessment or opinion related to the particular product included within user generated online communication information wherein user generated online communication information includes instant messages, social network communications, forum posts, blog posts, or email communications, and wherein the user generated online communication information does not include the user generated online review information and is generated in an opinion format and using social communication sources, including instant messengers, social networks, user interest forums, user interest blogs, or email communication sources;
extracting the online communication information related to an assessment or opinion related to the particular product;
determining whether the online review information and the online communication information related to an assessment or opinion includes fraudulent information;
filtering out the fraudulent information from the online review information and the online communication information related to an assessment or opinion to generate genuine online review information and genuine online communication information related to an assessment or opinion, wherein generating genuine online review information and genuine online communication information is based on at least one or more internet protocol addresses associated with the online review information and the online communication information; and
integrating the genuine online review information and the genuine online communication information related to an assessment or opinion to create a review summary for the product.

11. The system of claim 10, wherein the one or more server computers are further configured for:
assigning a weight to each of the genuine online review information and the genuine online communication information related to an assessment or opinion.

12. The system of claim 10, wherein collecting the user generated online review information comprises periodically searching for the user generated online review information.

13. The system of claim 10, wherein detecting online communication information related to an assessment or opinion related to the product comprises determining whether one or more of instant messages, social network communications, forum posts, blog posts, and email communications comprise the information related to an assessment or opinion related to the product.

14. The system of claim 11, wherein generating a review summary comprises ranking the genuine online review information and the genuine online communication information related to an assessment or opinion based at least in part on the respective weight.

15. The system of claim 10, wherein generating a review summary comprises assigning a star rating to the product based at least in part on the genuine online review information and the genuine online communication information related to an assessment or opinion.

16. The system of claim 10, wherein the review summary comprises price related information for the product.

17. The system of claim 11, wherein the weight is assigned based at least in part on one or more of a number of likes or dislikes assigned to the genuine online review information, an age of the genuine online review information and the genuine online communication information related to an assessment or opinion.

18. The system of claim 10, further comprising:
transmitting the review summary for display in a browser application window.

19. The system of claim 10, further comprising:
storing the user generated online review information in cloud storage.

20. A non-transitory computer readable storage medium having stored thereon instructions for causing a computer to execute a method, the method comprising:
collecting user generated online review information related to a particular product, wherein the user generated online review information is generated in a formal review format, wherein the format is provided by a commercial source and wherein the generated online review is stored with the commercial source, wherein the commercial source includes retailers, product manufacturers, auction marketplaces or commercial websites;
detecting at least online communication information related to an assessment or opinion related to the particular product included within user generated online communication information by determining whether one or more of instant messages, social network communications, forum posts, blog posts, and email communications comprise the information related to an assessment or opinion related to the product, and wherein the user generated online communication information does not include the user generated online review information and is generated in an opinion format and using social communication sources, including instant messengers, social networks, user interest forums, user interest blogs, or email communication sources;
extracting the online communication information related to an assessment or opinion related to the particular product;
determining whether the online review information and the online communication information related to an assessment or opinion includes fraudulent information;
filtering out the fraudulent information from the online review information and the online communication information related to an assessment or opinion to generate genuine online review information and genuine online communication information related to an assessment or opinion, wherein generating genuine online review information and genuine online communication information is based on at least one or more internet protocol addresses associated with the online review information and the online communication information;
integrating the genuine online review information and the genuine online communication information related to an assessment or opinion to create a review summary for the product; and
transmitting the review summary for display in a browser application window.
